(19) United States
(12) Patent Application Publication
(10) Pub. No.: US 2010/0172520 A1
(43) Pub. Date: Jul. 8, 2010

(54) ASSEMBLING METHOD OF SPEAKER AND ELECTRONIC APPARATUS EMPLOYING THAT SPEAKER

(76) Inventors: Takeshi Shimokawatoko, Mie (JP); Koji Sano, Mie (JP); Kazuki Honda, Mie (JP); Mitzukazu Kuze, Mie (JP); Shinya Mizone, Mie (JP)

Correspondence Address: RATNERPRESTIA, P.O. BOX 980, VALLEY FORGE, PA, 19482, US

(21) Appl. No.: 12/601,925

(22) PCT Filed: Jun. 5, 2008
(86) PCT No.: PCT/JP2008/001433

§ 371 Date: Nov. 25, 2009

(30) Foreign Application Priority Data
Jul. 25, 2007 (JP) 2007-192811

(51) Int. Cl. H04R 1/02; B23P 11/00

(52) U.S. Cl. 381/166; 29/428

(57) ABSTRACT

A voice coil wound to have a loop having an inner side is fixed to a diaphragm vibrating in a vibration direction. A first magnet having a first pole surface is fixed to an upper case. A second magnet having a second pole surface is fixed to a lower case. A first magnetic fluid is attached to the first pole surface of the first magnet after fixing the first magnet to the upper case. The diaphragm is fixed to the upper case after fixing the voice coil to the diaphragm and after attaching the first magnetic fluid to the first pole surface of the first magnet, such that the first pole surface of the first magnet faces the inner side of the voice coil and that the first magnetic fluid is provided between the first pole surface of the first magnet and the voice coil and contacts the first pole surface and the voice coil.

### TECHNICAL FIELD

The present invention relates to a method of manufacturing a thin loudspeaker and an electronic device including the loudspeaker.

### BACKGROUND ART

Electronic devices, such as portable devices, are demanded to be thin, and a loudspeaker accommodated in cases of the devices are accordingly required to be thin. In order to reduce a thickness of a conventional loudspeaker disclosed in Patent Document 1, a magnet forming a magnetic circuit is to have a small size. Such small magnet generates a small magnetic energy, accordingly reduces an audio output. Therefore, the magnet cannot be too small, and prevents the conventional loudspeaker from having a small thickness.

Patent Document 1: JP2005-51283A

### SUMMARY OF THE INVENTION

A voice coil wound to have a loop having an inner side is fixed to a diaphragm vibrating in a vibration direction. A first magnet having a first pole surface is fixed to an upper case. A second magnet having a second pole surface is fixed to a lower case. A first magnetic fluid is attached to the first pole surface of the first magnet after fixing the first magnet to the upper case. The diaphragm is fixed to the upper case after fixing the voice coil to the diaphragm and after attaching the first magnetic fluid to the first pole surface of the first magnet, such that the first pole surface of the first magnet faces the inner side of the voice coil and that the first magnetic fluid is provided between the first pole surface of the first magnet and the voice coil and contacts the first pole surface and the voice coil.

This method provides a loudspeaker having a small thickness but producing a high audio output, while preventing rolling.

### BRIEF DESCRIPTION OF THE DRAWINGS

FIG. 1 is a perspective view of an electronic device including a loudspeaker in accordance with an exemplary embodiment of the present invention.

FIG. 2 is a perspective view of the electronic device including the loudspeaker in accordance with the embodiment.

FIG. 3 is an exploded perspective view of the loudspeaker in accordance with the embodiment.

FIG. 4 is a cross-sectional view of the loudspeaker at line 4-4 shown in FIG. 2.

FIG. 5A is a cross-sectional view of the loudspeaker at line 5A-5A shown in FIG. 2.

FIG. 5B is an enlarged cross-sectional view of the loudspeaker shown in FIG. 5A.

FIG. 6 is an exploded perspective view of the loudspeaker in accordance with the embodiment.

FIG. 7 is an enlarged cross-sectional view of the loudspeaker shown in FIG. 5A.

### REFERENCE NUMERALS

1 Case
6E Lower Case
7 Magnet (Second Magnet)
7C Pole surface (Second Pole Surface)
9 Diaphragm
10 Voice Coil
10A Longitudinal Portion (First Longitudinal Portion)
10B Connection Portion
12 Magnet (First Magnet)
12A Pole Surface (First Pole Surface)
14 Magnetic Fluid (First Magnetic Fluid)
15 Upper Case
51A Longitudinal Direction
51B Vibration Direction
52 Magnetic Circuit
53 Magnetic Circuit
110A Longitudinal Portion (Second Longitudinal Portion)
110B Connection Portion
112 Magnet (Third Magnet)
112A Pole surface (Third Pole Surface)
114 Magnetic Fluid (Second Magnetic Fluid)
1001 Electronic Device
1002 Loudspeaker

### DETAILED DESCRIPTION OF PREFERRED EMBODIMENT

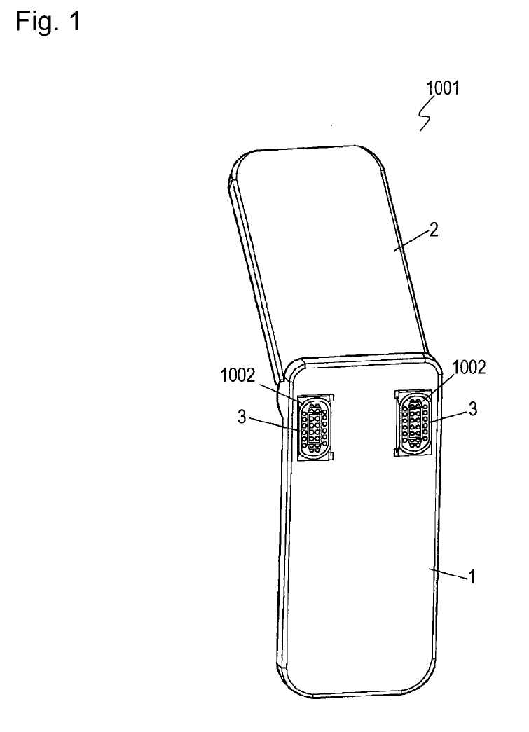

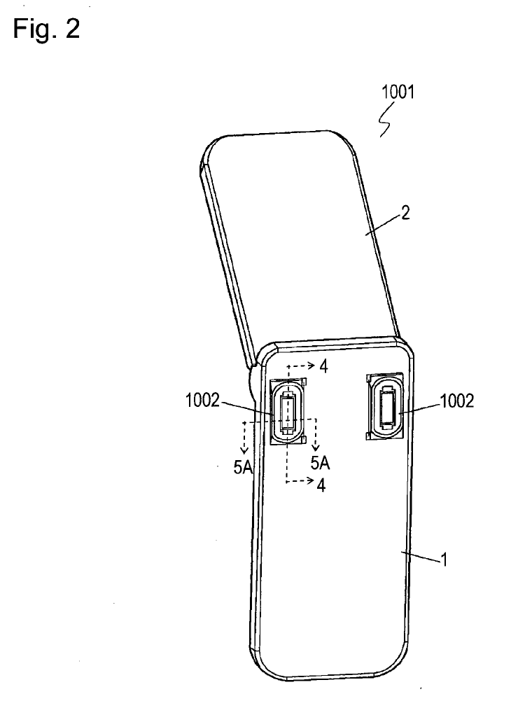

FIGS. 1 and 2 are perspective views of electronic device 1001 including loudspeaker 1002 in accordance with an exemplary embodiment of the invention. Electronic device 1001 is a cellular phone. Case 1 is coupled with lid 2 capable of opening and closing. Operation buttons are provided on a surface of case 1 facing lid 2. A liquid crystal display (LCD) is provided on a surface of lid 2 facing case 1. Loudspeaker 1002 is installed in case 1 and covered by cover 3.

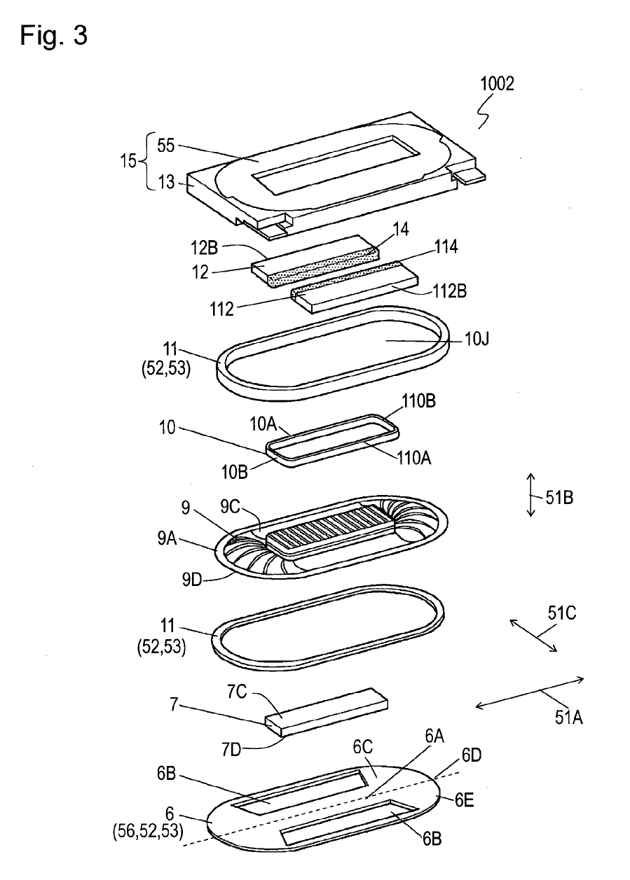

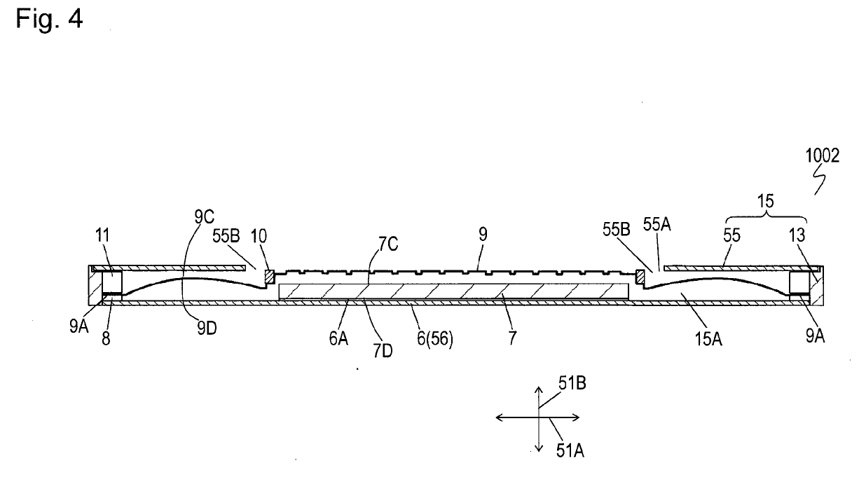

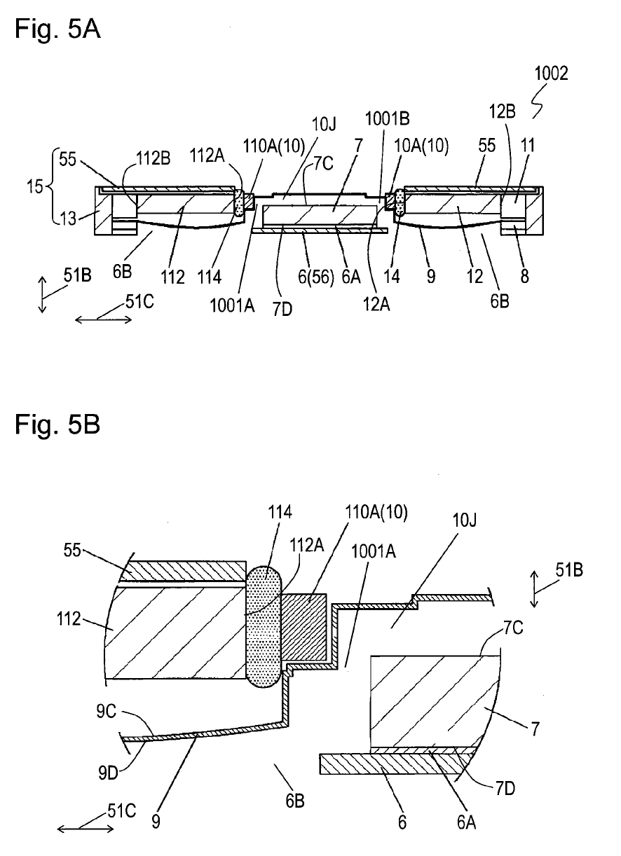

FIG. 3 is an exploded perspective view of loudspeaker 1002. FIGS. 4 and 5A are cross-sectional views of loudspeaker 1002 at lines 4-4 and line 5A-5A shown in FIG. 2, respectively. FIG. 5B is an enlarged cross-sectional view of loudspeaker 1002 shown in FIG. 5A. Upper case 15 made of non-magnetic material includes upper plate 55 made of non-magnetic metal, such as stainless steel (SUS 301), and frame 13 made of resin. Upper plate 15 has opening 15A which opens downward. Lower case 56 has lower plate 6 made of magnetic material, such as cold-rolled steel sheet, SPCC. Magnet 7 made of neodymium, ring 8 made of magnetic material, such as SPCC, diaphragm 9 made of resin, such as polyetherimide (PEI) film, voice coil 10 made of a metal wire, such as a copper wire, ring 11 made of magnetic material, such as SPCC, and magnets 12 and 112 made of neodymium are placed between lower plate 6 and upper plate 5 (55). Magnets 12 and 112 have a plate shape. Magnetic fluid 14 is provided between magnet 12 and voice coil 10. Magnetic fluid 114 is provided between magnet 112 and voice coil 10. Magnetic fluid 14 and 114 have gel form.

Lower plate 6 has an oval shape extending in longitudinal direction 51A. A copper wire is winded in a loop having inside 10J. Lower plate 6 has center axis 6D extending to longitudinal direction 51A. Fixing area 6A having s a rectangular shape extending along center axis 6D is provided on upper surface 6C of lower plate 6. Magnet 7 having a rectangular parallelepiped shape is bonded onto fixing area 6A with an adhesive. Openings having a rectangular shape are formed in both sides of fixing area 6B of lower plate 6.

Ring 8 is fixed onto upper surface 6C of outer periphery 6E of lower plate 6 while allowing magnetic flux to pass through ring 8 and lower plate 6. Outer periphery 9A of diaphragm 9 is placed on ring 8. Ring 11 is placed on upper surface 9C of diaphragm 9 at outer periphery 9A. Thus, outer periphery 9A of diaphragm 9 is sandwiched and held between rings 8 and 11.

Two first magnets 12 and 112 are bonded onto lower surface 5D of upper plate 55 with adhesives above upper surface 9C of diaphragm 9. Magnets 12 and 112 face openings 6B of lower plate 6B across diaphragm 9, respectively. Respective parts of the adhesives bonding magnets 12 and 112 onto upper plate 5 (55) flow into gaps between outer respective outer surfaces of magnets 12 and 112 and inner peripheral surface of frame 13, thereby fixing magnets 12 and 112 to frame 13.

Diaphragm 9 has an oval shape extending in longitudinal direction 51A and vibrates in vibration direction 51B perpendicular to longitudinal direction 51A. Diaphragm 9 has upper surface 9C and lower surface 9D. Voice coil 10 is fixed onto a portion of upper surface of diaphragm 9 facing an outer periphery of second magnet 7. Voice coil 10 has substantially an oval shape which extends in longitudinal direction 51A and which has longitudinal portions 10A and 110A extending in longitudinal direction 51A and connection portions 10B and 110B to bridge longitudinal portions 10A and 110A with each other.

Magnet 12 has pole surface 12A facing longitudinal portion 10A of voice coil 10. Pole surface 12A is directed toward direction 51C perpendicular to both longitudinal direction 51A and vibration direction 51B to face inside 10J of voice coil 10 having an oval shape. Magnet 112 has pole surface 112A facing longitudinal portion 110A of voice coil 10. Pole surface 112A is directed toward direction 51C to face inside 10J of voice coil 10 having the oval shape. Pole surfaces 12A and 112A are edge faces of the plate shapes of magnets 12 and 112. Magnetic fluid 14 is provided between pole surface 12A of magnet 12 and voice coil 10 and contacts pole surface 12A and voice coil 10. Magnetic fluid 114 is provided between pole surface 112A of magnet 112 and voice coil 10 to contact pole surface 112A and voice coil 10, as shown in FIG. 5B. Magnets 12 and 112 have pole surfaces 12B and 112B opposite to pole surfaces 12A and 112A, respectively. Pole surfaces 12A and 112A have polarities opposite to those of pole surfaces 12B and 112B, respectively. Pole surfaces 12B and 112B are edge faces of the plate shapes of magnets 12 and 112, respectively. Magnet 7 is placed in inside 10J of the oval shape of voice coil 10, and has pole surface 7C directed upward and pole surface 7D directed downward opposite to pole surface 7C. Pole surfaces 7C and 7D are upper and lower surfaces of the plate shape of magnet 7, respectively. Pole surface 7C has a polarity opposite to that of pole surface 7D. Pole surfaces 12B and 112B are fixed onto an inner surface of ring 11.

A method of assembling loudspeaker 1002 will be described below. First, upper case 15 having with magnets 12 and 112 mounted thereto is placed on a working table. Magnetic fluids 14 and 114 are adhered onto pole surfaces 12A and 112A of magnets 12 and 112, respectively. Then, diaphragm 9 having voice coil 10 fixed thereto is inserted from opening 15A of upper case 15 on this working table while longitudinal portions 10A and 110A of voice coil 10 contact magnetic fluids 14 and 114, respectively. Then, lower plate 6 having magnet 7 mounted thereto is inserted from opening 15A of upper case 15 to fix lower plate 6 onto upper case 15, thereby assembling loudspeaker 1002 efficiently and reliably.

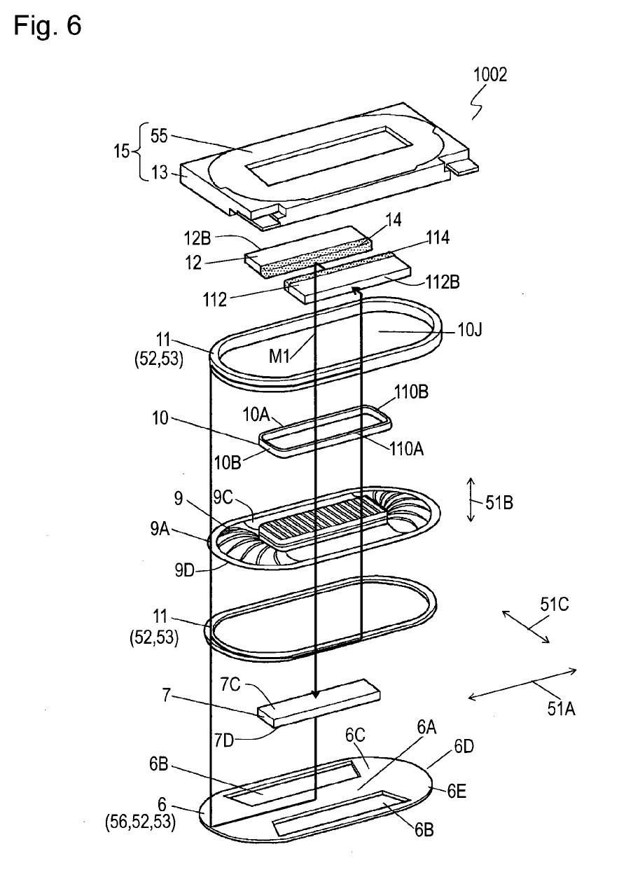

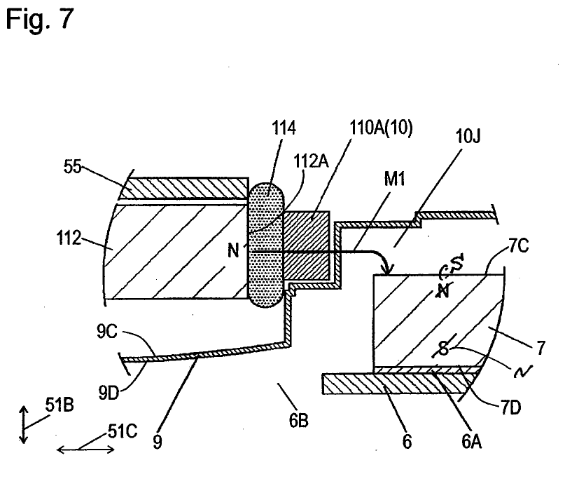

FIG. 6 is an exploded perspective view of loudspeaker 1002 for illustrating magnetic flux M1. FIG. 7 is an enlarged cross-sectional view of loudspeaker 1002 shown in FIG. 6. Pole surfaces 12A and 112A of magnets 12 and 112 are magnetized in N-pole. Pole surfaces 12B and 112B are magnetized in S-pole, as shown in FIG. 7. Pole surface 7C and pole surface 7D of magnet 7 are magnetized in S-pole and N-pole, respectively.

Magnetic flux M1 emitted from pole surface 112A of magnet 112 magnetized in N-pole passes through magnetic fluid 114, crosses longitudinal portion 110A of voice coil 10 substantially perpendicularly, and reaches pole surface 7C of magnet 7 magnetized in S-pole. Magnetic flux M1 crosses longitudinal portion 110A in direction 51C perpendicular to longitudinal direction 51A and vibration direction 51B. Magnets 12 and 112 are arranged horizontally or practically horizontally from magnet 7 in order to allow magnetic flux M1 to cross voice coil 10 in direction 51C. Magnets 12 and 112 overlap with magnet 7 partially in vibration direction 51B, or are close to each other if they don't overlap in vibration direction 51B as shown in FIG. 5A.

Magnetic flux M1 reaching pole surface 7C of magnet 7 is emitted from pole surface 7D, flows along fixing area 6A of lower plate 6 in longitudinal direction 51A to reach ring 8 and then to reach ring 11 through outer periphery 9C of diaphragm 9. Since rings 8 and 11 are made of magnetic material, magnetic flux M1 reaching rings 8 and 11 flows, for instance, in one forth of respective circumstances of rings 8 and 11, and subsequently reaches pole surface 12B of magnet 12 fixed to ring 11. Similarly to magnetic flux M1, other fluxes emitted from magnet 12 return back to magnet 12 through magnetic fluid 114, magnet 7, lower plate 6, and rings 8 and 11.

As described above, magnetic fluid 114, lower plate 6, and rings 8 and 11 constitute magnetic circuit 52 in which magnetic flux M1 flows to couple magnets 112 and 7 magnetically to each other. Magnetic circuit 52 includes magnetic gap 1001A formed between pole surface 112A of magnet 112 and pole surface 7C of magnet 7. Longitudinal portion 110A of voice coil 10 is located in magnetic gap 1001A so as to be displaced in vibration direction 51B due to magnetic flux M1 and a current flowing in voice coil 10. Diaphragm 9 fixed to voice coil 10 is displaced in vibration direction 51B according to the displacement of voice coil 10, thereby vibrating to output sounds.

Similarly, magnetic fluid 14, lower plate 6, and ring 8 and 11 constitute magnetic circuit 53 in which magnetic flux flows to couple magnets 12 and 7 magnetically to each other. Magnetic circuit 53 includes magnetic gap 1001B formed between pole surface 12A of magnet 12 and pole surface 7C of magnet 7. Longitudinal portion 10A of voice coil 10 is located in magnetic gap 1001B so as to be displaced in vibration direction 51B according to the magnetic flux and a current flowing in voice coil 10. Diaphragm 9 fixed to voice coil 10 is displaced in vibration direction 51B according to the displacement of voice coil 10, thereby vibrating to output sounds.

As shown in FIG. 7, magnetic flux M1 emitted from pole surface 112A (12A) of magnet 112 (12) magnetized in N-pole flows through magnetic gap 1001A in direction 51C perpendicular to longitudinal direction 51A and vibration direction 51B to crosses longitudinal portion 110A (10A) of voice coil 10 substantially perpendicularly. This arrangement displaces voice coil 10 sue to a large electro-magnetic force generated by magnetic flux M1 and a current flowing in voice coil 10. In general, magnetic flux M1 emitted from pole surface 112A (12A) of magnet 112 (12) tend to flow not in a direction perpendicular to vibration direction 51B of diaphragm 9 but in a direction inclining against vibration direction 51B to flow straight toward pole surface 7C of magnet 7 magnetized in S-pole. However, pole surface 7D of magnet 7 magnetized in N-pole repels and raises the path of magnetic flux M1, thereby causing magnetic flux M1 to cross longitudinal portion 110A (10A) substantially perpendicularly in direction 51C perpendicular to vibration direction 51B.

Magnets 12 and 112 and magnet 7 have a plate shape having a small thickness in vibration direction 51B, thus reducing an overall thickness of loudspeaker 1002.

In loudspeaker 1002 in accordance with the embodiment, magnetic fluid 14 contacting pole surface 12A and voice coil 10 is provided between pole surface 12A of magnet 12 and voice coil 10, and magnetic fluid 114 contacting pole surface 112A and voice coil 10 is provided between pole surface 112A of magnet 112 and voice coil 10. Magnetic fluid 14 and 114 do not prevent voice coil 10 from being displaced in vibration direction 51B. When voice coil 10 is displaced in direction 51C perpendicular to vibration direction 51C, a clearance between longitudinal portion 10A of voice coil 10 and pole surface 12A and a clearance between longitudinal portion 110A and pole surface 112A change to compress and expand magnetic fluid 14 and 114. Magnetic fluid 14 and 114 have their viscosity preventing from being compressed and expanded. This reduces a rolling, the displacement of voice coil 10 in direction 51C, and thus, reduces defective gaps. Magnetic fluid 14 and 114 contacting voice coil 10 can dissipate heat generated in voice coil 10 to outside, and accordingly, allows a current flow in voice coil 10 to increase, thus providing loudspeaker 1002 with resistance to a high input power.

Even a loudspeaker including a magnetic circuit having an annular magnetic gap can include a magnetic fluid in the magnetic gap between a voice coil and the magnetic circuit. In this case, however, the magnetic fluid seals the magnetic gap completely, thereby sealing up air inside the loudspeaker. Thus, the magnetic fluid prevents airflow, and may deteriorate a property of the loudspeaker. In loudspeaker 1002 in accordance with the embodiment, magnetic fluid 14 is provided only between pole surface 12A of magnet 12 and longitudinal portion 10A of voice coil 10, and magnetic fluid 114 is provided only between pole surface 112A of magnet 112 and longitudinal portion 110A of voice coil 10. Namely, as shown in FIG. 4, no magnetic fluid is provided between magnetic circuit 52 and each of connection portions 10B and 110B longitudinal portions 10A and 110A of the substantially oval shape of voice coil 10 with each other, thus providing clearances 55B. Clearances 55B prevent the magnetic fluids from sealing up magnetic gap 1001A completely, and prevent a space surrounded by upper case 15 and diaphragm 9 from being sealed consequently. This arrangement does not block air flow, not restricting the vibration of diaphragm 9.

According to the embodiment, terms indicating directions, such as “upper”, “lower”, “upward2”, and “downward”, indicates relative directions determined by the relative positional relationship of components of loudspeaker 1002, and do not indicate absolute directions, such as a vertical direction.

### INDUSTRIAL APPLICABILITY

An assembling method according to the present invention provides a thin loudspeaker that can produce a high audio output while preventing a rolling, thus being useful for mobile devices, such as cellular phones.

1. A method of manufacturing a loudspeaker, comprising:
fixing a voice coil to a diaphragm vibrating in a vibration direction, the voice coil being wound to have a loop having an inner side;
fixing a first magnet to an upper case, the first magnet having a first pole surface;
fixing a second magnet to a lower case, the second magnet having a second pole surface;
attaching a first magnetic fluid to the first pole surface of the first magnet after said fixing the first magnet to the upper case; and
fixing the diaphragm to the upper case after said fixing the voice coil to the diaphragm and after said attaching the first magnetic fluid to the first pole surface of the first magnet, such that the first pole surface of the first magnet faces the inner side of the voice coil and that the first magnetic fluid is provided between the first pole surface of the first magnet and the voice coil and contacts the first pole surface and the voice coil; and
attaching the lower case to the upper case after said fixing the second magnet to the lower case and after said fixing the diaphragm to the upper case, such that such that a magnetic flux passing through the first pole surface of the first magnet crosses the voice coil in a direction perpendicular to the voice coil and the vibration direction and that the second pole surface is located inside the inner side of the voice coil.

2. The method according to claim 1, further comprising
providing a magnetic circuit to coupling the first magnet magnetically with the second magnet.

3. The method according to claim 1, wherein
the first magnet and the second magnet extend in a longitudinal direction, and
the first pole surface of the first magnet and the second pole surface of the second magnet extend in the longitudinal direction.

4. The method according to claim 3, further comprising:
fixing a third magnet having a third pole surface to the upper case; and
attaching a second magnetic fluid to the third pole surface of the first magnet after said fixing the third magnet to the upper case, wherein
a third magnet having a third pole surface extending in the longitudinal direction and facing the inner side of the voice coil; and
a second magnetic fluid provided between the third pole surface of the third magnet and the voice coil and contacting the third pole surface and the voice coil, wherein
said fixing the diaphragm to the upper case comprises fixing the diaphragm to the upper case after said attaching the second magnetic fluid to the third pole surface of the first magnet, such that the third pole surface faces the inner side of the voice coil and that a magnetic flux passing through the third pole surface of the third magnet crosses the voice coil in a direction perpendicular to the voice coil and the vibration direction.

5. The method according to claim 4, wherein
the voice coil has substantially an oval shape extending to the longitudinal direction, the voice coil having a first longitudinal portion extending in the longitudinal direction, a second longitudinal portion extending in the longitudinal direction, and a connection portion to bridge the first longitudinal portion with the second longitudinal portion,
said fixing the diaphragm top the upper case comprises fixing the diaphragm top the upper case, such that the first pole surface of the first magnet faces the first longitudinal portion of the voice coil and that the third pole surface of the third magnet faces the second longitudinal portion of the voice coil.

6. The loudspeaker according to claim 1, wherein the first pole surface of the first magnet is magnetized in N-pole.

7. An electronic device comprising:
the loudspeaker manufactured by the method according to claim 1; and
a case accommodating the loudspeaker.

8. An electronic device comprising:
the loudspeaker manufactured by the method according to claim 2; and
a case accommodating the loudspeaker.

9. An electronic device comprising:
the loudspeaker manufactured by the method according to claim 3; and
a case accommodating the loudspeaker.

10. An electronic device comprising:
the loudspeaker manufactured by the method according to claim 4; and
a case accommodating the loudspeaker.

11. An electronic device comprising:
the loudspeaker manufactured by the method according to claim 5; and
a case accommodating the loudspeaker.

12. An electronic device comprising:
the loudspeaker manufactured by the method according to claim 6; and
a case accommodating the loudspeaker.
